(19) United States
(12) Patent Application Publication
(10) Pub. No.: US 2002/0080442 A1
(43) Pub. Date: Jun. 27, 2002

(54) Optical cross-connect for optional interconnection of communication signals of different multiplex levels

(75) Inventors: Werner Beisel, Ludwigsburg (DE); Volker Hagele, Schorndorf (DE); Heinz Wettengel, Ditzingen (DE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 10/020,178

(22) Filed: Dec. 18, 2001

(30) Foreign Application Priority Data
Dec. 23, 2000 (DE) 100 65 000.7

(51) Int. Cl. H04J 14/00; H04J 14/02

(52) U.S. Cl. 359/117; 359/128

(57) ABSTRACT

An optical cross-connect (OCX), which is designed for switching so-called optical channels of different multiplex levels with respectively defined bit rates, comprises a number of input/output ports (IO1, IO2, IO3) which are respectively adapted for transmitting and receiving communication signals of a given multiplex level. The cross-connect further comprises, for each multiplex level, a separate space switching matrix (S1, S2, S3) which is adapted to that multiplex level. The individual switching matrices (S1, S2, S3) are interconnected via multiplexers (MUX1, MUX2). Communication signals which are to be switched to an output of the same multiplex level are switched directly by the respective switching matrix to the respective output, whereas communication signals which are to be switched to an output of a lower or higher multiplex level are first switched by the respective switching matrix to one of the multiplexers, where they are multiplexed or demultiplexed and then forwarded to the switching matrix of the next-higher or next-lower multiplex level respectively, which then switches the multiplexed or demultiplexed communication signals to the respective input.

The invention is based on a priority application DE 10065000.7, which is incorporated by reference herein.

### FIELD OF THE INVENTION

The invention relates to the field of telecommunications and more particularly to an optical cross-connect for switching connections in an optical transmission network, in which optical communication signals of different multiplex levels with respectively defined bit rates can be transmitted, communication signals of a higher multiplex level being composed of communication signals of a lower multiplex level or directly containing a payload data signal.

### BACKGROUND OF THE INVENTION

In optical communication transmission, synchronous optical systems are currently used which are known in Europe as SDH (synchronous digital hierarchy) and in North America as SONET (synchronous optical network) systems. These systems define communication signals of different hierarchy levels, with communication signals of a higher multiplex level being composed of communication signals of a lower multiplex level or directly containing a payload data signal. The multiplex hierarchy of these systems is defined in ITU-T G.707, Chapter 6. An overview of these systems is presented in, for example, the article “SONET 101” by the Nortel Networks company, which can be downloaded from the Internet address www.nortel.com/broadband/pdf/sonet 101.pdf.

In optical communication transmission networks, cross-connects are used which have the function of establishing paths in the network. For this purpose, it is necessary to be able to switch multiplex units from each input to each output. Known in the art are so-called 4/3/1 cross-connects such as, for example, the 1641 SX of the Alcatel company, which are able to switch multiplex units of all hierarchy levels (VC-4, VC3, VC-12 in the case of SDH) from each input to each output. In addition, there are also so-called 4/4 cross-connects such as, for example, the 1664SX of the Alcatel company, which are adapted for switching only multiplex units of the highest hierarchy level (in the case of SDN VC-4). The main item of this cross-connect is a space/time switching matrix which is connected to all input/output ports. In the case of the known systems, this switching matrix is in the form of a three-stage electrical switching matrix after Clos (see Clos, “A Study of Non-Blocking Switching Networks”, B.S.T.J. No. 32, 1953, pp. 406-424).

In addition, so-called optical cross-connects are currently being developed which are intended to switch optical communication signals of any format, such as SONET, ATM and IP. They comprise a central space switching matrix which is to be transparent to the communication signals to be switched. An example of such an optical cross-connect is presented in the article “Cost Effective Optical Networks: The Role of Optical Cross-Connects”, by Charles A. Brackett, which can be downloaded from the Internet site www.tellium.com.

More recent developments in optical communication transmission are directed at transmitting communication signals of increasingly higher bit rates. Thus, a new multiplex hierarchy known as “optical channel (OCh)” is currently under discussion. This new multiplex hierarchy is intended to have multiplex levels with bit rates of 2.66 Gbit/sec. and multiples (factor four) of that rate, namely, 10.7× Gbit/sec. and 43.× Gbit/sec. The future optical channels are intended, in particular, for optical communication transmission in wavelength division multiplex (WDM). This system is referred to as Optical Transport Network (OTN) and standardized in ITU-T G.709 (2001), which is incorporated by reference herein.

These optical channels also require cross-connects which are capable of switching communication signals of all hierarchy levels from each input to each output. For the switching matrix of such cross-connects, the approach with a three-stage electrical space/time matrix after Clos cannot be achieved at a warrantable cost, due to the high bit rate. Optical cross-connects with a transparent space switching matrix, however, are not capable of connecting ports for communication signals of a higher multiplex level to ports for communication signals of a lower multiplex level. On the other hand, such optical cross-connects are far from cost effective for the new optical channels.

### SUMMARY OF THE INVENTION

The object of the invention, therefore, is to provide a cross-connect for optical channels which supports full connectivity for communication signals of all multiplex levels. A further object of the invention is to disclose a method for switching optical channels of different multiplex levels.

The object is achieved by a cross-connect which has a separate switching matrix for each multiplex level. Each switching matrix is adapted for switching communication of the respective multiplex level and is connected to the input/output ports of this multiplex level. Moreover, each switching matrix is connected, via at least one multiplexer, to the switching matrix of the next-higher multiplex level. The multiplexer is adapted for multiplexing a number of communication signals received from the switching matrix of the lower multiplex level to form a communication signal of a next-higher multiplex level and for forwarding this latter communication signal to the switching matrix of the next-higher multiplex level, and for demultiplexing a communication signal received from the switching matrix of a higher multiplex level into a number of communication signals of a next-lower multiplex level and for singly forwarding these latter communication signals to the switching matrix of the next-lower multiplex level.

The cross-connect operates as follows: It receives an optical communication signal and ascertains the hierarchy level of the communication signal. Then it feeds the communication signal to a switching matrix which is specifically adapted for this hierarchy level. The cross-connect ascertains the output to which the communication signal is to be switched. If the communication signal is to be switched to an output which supports the same hierarchy level, it switches the communication signal to this respective output. If the communication signal is to be switched to an output which supports a higher hierarchy level, it switches the communication signal to a first multiplexer. The first multiplexer multiplexes the communication signal to form a communication signal of the higher hierarchy level. The latter signal is then forwarded to the second switching matrix which is adapted for communication signals of the higher hierarchy level, and switched to the respective output. If the communication signal is to be switched to an output which supports a lower hierarchy level, then the cross-connect switches the communication signal to a second multiplexer; which demultiplexes the communication signal to form communication signals of the lower hierarchy level and forwards these to a third switching matrix which is adapted for communication signals of the lower hierarchy level. The demultiplexed communication signals are then switched to the respective output ports.

The invention has the advantage that a switching matrix which is adapted to the bit rate can be used for communication signals of each multiplex level, that the cross-connect can be flexibly expanded and can be adapted to the intended application in respect of capacity and number of individual input/output ports.

### BRIEF DESCRIPTION OF THE DRAWINGS

The invention is described more fully below with reference to an embodiment example and with the aid of FIGS. 1 and 2, wherein:

FIG. 1: shows the schematic structure of an optical cross-connect, and

FIG. 2: shows the structure of the cross-connect according to the invention.

### DETAILED DESCRIPTION OF THE INVENTION

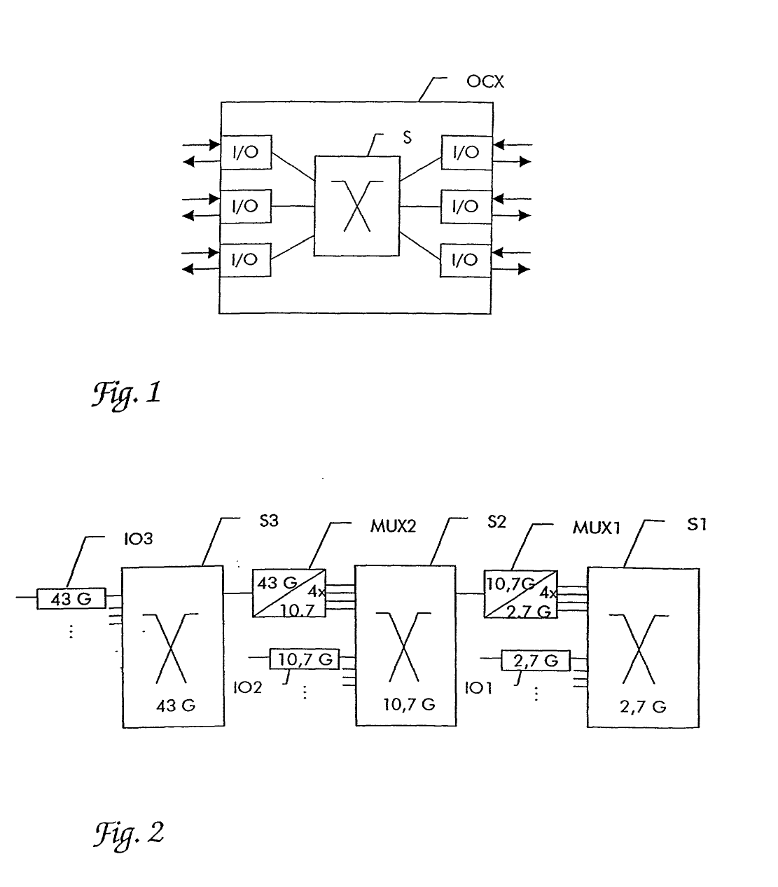

FIG. 1 presents the usual design of a cross-connect OCX. It comprises a number of optical input/output ports I/O, all of which are connected to a switching matrix S. The switching matrix S can thus switch each input to any output. In the case of known 4/3/1 cross-connects for SDH, the matrix is a space/time switching matrix which can switch any multiplex units, down to the lowest multiplex level, from any inputs to any outputs. In the case of known optical cross-connects, the switching matrix is a space switching matrix which is transparent to any signal formats. In these cases, however, only inputs of the same kind can be switched to outputs of the same kind. Thus, there would be no point in switching an ATM input to an STM-64 output, or the reverse.

According to the invention, the input/output ports I/O for communication signals are designed according to the definition of the optical channel (OCh,). These are based on a basic bit rate of 2.66 Gbit/sec., higher multiplex levels having four times the bit rate of the basic bit rate. Communication signals of a higher multiplex level are formed through byte-embedding of four communication signals of the respectively next-lower multiplex level, or directly contain a payload data signal. In the multiplexing of communication signals of a lower multiplex level to form a communication signal of a next-higher multiplex level, byte-stuffing is used to equalize frequency differences of the sub-signals. Hitherto, provision has been made for two higher multiplex levels, with bit rates of 10.7× Gbit/sec. and 43.× Gbit/sec. The exact bit rate has not yet been finally determined, so that the final effective bit rate position is denoted by x. It is assumed that further, higher multiplex levels will be determined in future.

A fundamental concept of the invention is to use a separate space switching matrix for each multiplex level which is adapted to the latter and to connect the individual switching matrices via multiplexers. Communication signals which are to be switched to an output of the same multiplex level are switched directly by the switching matrix to the respective output, whereas communication signals which are to be switched to an output of a lower or higher multiplex level are first switched by the switching matrix to the multiplexer, where they are multiplexed or demultiplexed, and then forwarded to the switching matrix of the next-higher or next-lower multiplex level respectively, which then connects the respectively multiplexed or demultiplexed communications to the respective input. The multiplexers thus effect inter-operation between the multiplex levels.

Such a cross-connect is presented in FIG. 2. This comprises a series of input/output ports IO1, IO2, IO3 for optical communication signals of the different multiplex levels. The input/output ports of the cross-connect can be divided into three groups: a first group of ports IO1 for communications signals of the lowest multiplex level, with a bit rate of 2.66 Gbit/sec., a second group of ports IO2 for communications signals of the second multiplex level, with a bit rate of 10.7× Gbit/sec., and a third group of ports for communication signals of the highest multiplex level, with a bit rate of 43.× Gbit/sec.

A first switching matrix S1 is provided and adapted for switching communication signals of the lowest multiplex level, with a bit rate of 2.66 Gbit/sec. Connected to this first switching matrix S1 are the input/output ports of the first group IO1 for communication signals of the lowest multiplex level. Furthermore, the cross-connect comprises a second switching matrix for communications signals of the second multiplex level and a switching matrix S3 for communication signals of the third, highest multiplex level. The input/output ports of the second group IO2 for communication signals of the second, middle multiplex level are connected to the second switching matrix S2 and the input/output ports of the third group IO3 for communication signals of the third, highest multiplex level are connected to the third switching matrix S3. In addition, the first switching matrix S1 is connected to the second switching matrix S3 via a first multiplexer MUX1 and the second switching matrix is connected to the third switching matrix via a second multiplexer MUX2.

The first multiplexer MUXI is provided for the multiplexing and corresponding demultiplexing of communication signals of the lowest multiplex level into communication signals of the second, middle multiplex level. The second multiplexer MUX2 is provided for the multiplexing and corresponding demultiplexing of communication signals of the second multiplex level into communication signals of the highest multiplex level. The two multiplexers each comprise four ports for communication signals of the respectively lower multiplex level, as well as a port for communication signals of the higher multiplex level. The four low-bit-rate ports are respectively connected to ports of the space switching matrix of the lower multiplex level and the high-bit-rate port is respectively connected to a port of the switching matrix of the higher multiplex level.

The cross-connect operates as follows: Each switching matrix switches connections for communication signals on its multiplex level between any ports of the matrix. The switching state of each matrix is determined in this case by a control device, not shown, via a network management system.

Communication signals with a bit rate of 2.66 Gbit/sec. are received at the ports of the first group IO1. If a communication signal is to be switched from such a port to a port of the same type belonging to the same group IO1, the switching matrix S1 switches this communication signal directly to the respective port. Likewise, communication signals at the ports of the groups IO2 and IO3 are switched directly, by the switching matrix S2, S3 respectively connected to them, to the respective outputs, if the latter belong to the same group. Otherwise, conversion must be effected in one of the multiplexers MUX1, MUX2.

A case is now assumed, by way of example, in which a communication signal of the lowest multiplex level (2.66 Gbit/sec.) is to be switched from a port of the first group IO1 to a port of the second group IO2. For this purpose, the 2.66 Gbit/sec. communication signal is switched to the first multiplexer MUX1 by the switching matrix. As already explained, the multiplexer MUX1 has four ports for communication signals of the lowest multiplex level and one port for signals of the middle multiplex level. The multiplexer effects byte-embedding of the communication signals received at the four ports of the lowest multiplex level to form a communication signal of the middle multiplex level, and forwards this to the switching matrix S2. This embedded communication signal is then switched by the switching matrix S2 to the respective output of the middle multiplex level. If the 2.66 Gbit/sec. communication signal described by way of example is the only communication signal to be switched to the respective output, the multiplexer embeds it with three dummy signals in order to form the communication signal of the middle multiplex level.

All switching states of the three switching matrices S1, S2, S3 and the operating modes of the multiplexers MUX1 and MUX2 are bi-directional. Thus, for example, even a communication signal from a port of the middle multiplex level can be switched, via the switching matrix S2, to the corresponding port of the first multiplexer MUX1. The latter demultiplexes the signal into four communication signals of the lowest multiplex level and forwards these to the switching matrix S1. The switching matrix S1 then switches these four communication signals to four different ports of the first group IO1.

If a communication signal of the lowest multiplex level is to be switched from a port of the first group IO1 to a port of the third group IO3, it is first switched, by the first switching matrix S1, to the first multiplexer MUX1. The latter, using three further communication signals or, possibly, dummy signals, then forms a communication signal of the middle multiplex level which is then forwarded to the second switching matrix S2. The second switching matrix S2 then switches the multiplexed communication signal of the middle multiplex level to the second multiplexer MUX2 which, in turn, using three further communication signals of the middle multiplex level or, possibly, dummy signals, forms from it a communication signal of the highest multiplex level by byte-embedding the four signals. The thus formed communication signal of the highest multiplex level is then switched to the respective output of the third group by the switching matrix S3.

The switching matrices S1, S2, S3 can be in the form of either electrical switching matrices or optical matrices, or even a combination of both. It is thus advantageous if the first and second switching matrices S1, S2 are each an electrical switching matrix and the third switching matrix S3 is an optical switching matrix. If the third switching matrix is to be an electrical switching matrix, it is advantageously designed for parallel signal processing, i.e., it comprises, for example, eight parallel paths for the eight bits of each byte of the communication signals to be switched. This is necessary in order that switching matrices for a maximum of 20 Gbit/sec. can be constructed with the currently most modern integrated semiconductor devices produced on the basis if SiGe technology. For example, an optical switching matrix can be constructed using small mirrors, so-called micro-mirrors.

The use of two multiplexers is not intended to constitute any limitation of the invention. Rather, several multiplexers of the same type can also be simultaneously connected between two switching matrices S1 and S2 or S2 and S3. This is advantageous in the case of large switching matrices with a switching capacity of several dozen communication signals, in order that several groups of four ports of a lower multiplex level can be simultaneously connected to ports of a higher multiplex level.

The cross-connect according to the invention is advantageously of modular construction, in the form of plug-in cards. This enables it to be flexibly expanded, e.g. through the addition of further multiplexer plug-in cards and matrix plug-in cards.

What is claimed is:

1. An optical cross-connect for switching connections in an optical transmission network, in which optical communication signals of different multiplex levels with respectively defined bit rates can be transmitted, communication signals of a higher multiplex level being composed of communication signals of a lower multiplex level or directly containing a payload data signal; the cross-connect containing a number of input/output ports which are respectively adapted for transmitting and receiving communication signals of a given multiplex level, wherein
for each multiplex level, there is provided a separate switching matrix which is adapted for switching communication of the respective multiplex level and which is connected to the input/output ports of this multiplex level, and
each switching matrix is connected, via at least one multiplexer, to the switching matrix of the next-higher multiplex level, the multiplexer being adapted for multiplexing a number of communication signals received from the switching matrix of the lower multiplex level to form a communication signal of a next-higher multiplex level and for forwarding this latter communication signal to the switching matrix of the next-higher multiplex level, and for demultiplexing a communication signal received from the switching matrix of a higher multiplex level into a number of communication signals of a next-lower multiplex level and for individually forwarding these latter communication signals to the switching matrix of the next-lower multiplex level.

2. An optical cross-connect according to claim 1, in which the switching matrices are transparent space switching matrices.

3. An optical cross-connect according to claim 2, in which at least one switching matrix is an optical space switching matrix.

4. An optical cross-connect according to claim 2, in which at least one switching matrix is an electrical space switching matrix.

5. An optical cross-connect according to claim 1, in which ports are respectively provided for a lowest hierarchy level with a bit rate of 2.66 Gbit/sec. and two higher hierarchy levels each with four times the bit rate of the next-lower hierarchy level and in which two multiplexers connect the three switching matrices for the three hierarchy levels, the first multiplexer being adapted for multiplexing four communication signals of the lowest hierarchy level to form one communication signal of the middle hierarchy level and the reverse, and the second multiplexer being adapted for multiplexing four communication signals of the middle hierarchy level to form one communication signal of the highest hierarchy level and the reverse.

6. An optical cross-connect according to claim 1, in which the subassemblies are modular, in the form of plug-in cards.

7. A method for switching optical communication signals of different multiplex levels with respectively defined bit rates, communication signals of a higher multiplex level being composed of communication signals of a lower multiplex level or directly containing a payload data signal, with the steps:
receiving of an optical communication signal;
ascertainment of the hierarchy level of the communication signal;
feeding of the communication signal to a switching matrix which is specifically adapted for this hierarchy level;
ascertainment of the output to which the communication signal is to be switched;
if the communication signal is to be switched to an output which supports the same hierarchy level, switching of the communication signal to the respective output, and
if the communication signal is to be switched to an output which supports a higher hierarchy level,
switching of the communication signal to a first multiplexer;
multiplexing of the communication signal to form a communication signal of the higher hierarchy level
forwarding of the multiplexed communication signal to the second switching matrix which is adapted for communication signals of the higher hierarchy level, and
switching of the communication signal to the respective output; and
if the communication signal is to be switched to an output which supports a lower hierarchy level,
switching of the communication signal to a second multiplexer;
demultiplexing of the communication signal to form communication signals of the lower hierarchy level
forwarding of the demultiplexed communication signals to a third switching matrix which is adapted for communication signals of the lower hierarchy level, and
switching of one of the demultiplexed communication signals to the respective output.
